(19) United States
(12) Patent Application Publication
(10) Pub. No.: US 2004/0021567 A1
(43) Pub. Date: Feb. 5, 2004

(54) Method and apparatus of distance-based location alarm

(76) Inventor: Tim Dunn, San Jose, CA (US)

Correspondence Address: ROSENTHAL & OSHA L.L.P. / SUN, 1221 MCKINNEY, SUITE 2800, HOUSTON, TX, 77010, US

(21) Appl. No.: 10/211,175

(22) Filed: Aug. 2, 2002

(51) Int. Cl. G08B 1/08

(52) U.S. Cl. 340/539.13

(57) ABSTRACT

An apparatus for distance computation includes a location determining device for determining a current location based on signals received from a positioning broadcast system; a memory for storing a coordinate of at least one reference location and at least one program for the distance computation; an input device for entering the coordinate of the at least one reference location; a microprocessor for calculating a distance between the current location and the at least one reference location, the microprocessor operatively coupled to the location determining device and the memory; and an output device operatively coupled to the microprocessor for outputting the calculated distance. The apparatus may further include an alarm setting device operatively coupled to the microprocessor for determining an alarm condition from the calculated distance; and an alarm triggerable by the alarm setting device.

### BACKGROUND OF INVENTION

Many devices are available for measuring distances or distance ranging. Examples include sonar-based, laser-based, and electro-optical ranging devices. Some of these devices are capable of highly accurate distance ranging. For example, scientists involved in the Lunar Laser Ranging Experiment have been able to use laser ranging to estimate the distance between moon and earth to an accuracy of a few centimeters. However, not every application of distance ranging requires such an accuracy. There are many every day applications that need only rough estimates of distances and do not justify the expense of highly accurate equipment like laser ranging devices. For example, one may be interested in knowing the distance around the neighborhood blocks where one jogs every morning. A device that can measure a distance with an accuracy of a few feet would be sufficient for this purpose. In addition, the laser or optical based devices require line of sight, which may not be possible in some situations.

The Global Positioning System, which is officially called the navigation satellite timing and ranging system (NAVSTAR), is a satellite-based navigation system made up of a network of 24 satellites placed into orbits by the U.S. Department of Defense. GPS satellites circle the earth twice a day in very precise orbits and transmit signals to earth.

The GPS includes three parts: the space segment (the satellites), the control system (ground control stations), and the GPS receivers (user devices). GPS satellites transmit two low power radio signals, designated L1 and L2. Civilian GPS receivers use the L1 frequency of 1575.42 MHz in the UHF band. The signals travel by line of sight, meaning that they pass through clouds, glass and plastic but not pass through most solid objects such as buildings and mountains. A GPS signal includes three different sets of information—a pseudorandom code, ephemeris data, and almanac data. The pseudorandom code (a series of zeroes and ones that appear to be random) is simply an identification code that identifies which satellite is transmitting the information. Ephemeris data include information about the status of the satellite (healthy or unhealthy) and information on current date and time. This part of the signal is essential for determining a position. The almanac data include information on where each GPS satellite should be at any time throughout the day. Almanac data transmitted by each satellite include orbit information not only for that particular satellite, but also for every other satellite in the system.

The date and time information in the signals from the satellites permits calculation of travel times of the signals from the satellites to the GPS receiver. The travel time multiplied by the speed of the radio wave gives the distance between the satellite and the receiver. In addition, the signals from the satellites also contain orbit information (the almanac data), which tells the location of the satellites at that moment. In order for these signals to produce accurate location, both the clock information and the orbit information must be accurate. The accuracy of the information is ensured by ground control stations. There are five ground stations spread across the globe: one main control station in Colorado and four unmanned stations on islands spaced across the globe. The ground control stations use the atomic clock to provide accurate clock signals for the satellites. In addition, these control stations also monitor actual positions of the satellites and send correction signals to compensate for any deviation from the intended orbits.

A GPS receiver compares the time a signal was transmitted by a satellite with the time the signal was received. The time difference tells the GPS receiver how far away the satellite is. With distance measurements from three or more satellites, the receiver can determine the user's position by triangulation. With only three distances from satellites, whose locations are known, a GPS receiver can calculate by triangulation a two-dimensional (2D) position (latitude and longitude) of a user and track the movement of the user. With four or more distances from satellites with known locations, the GPS receiver can determine the user's three-dimensional (3D) position (latitude, longitude, and altitude) and to track his movement.

Common GPS receivers can determine user locations with an accuracy of about 15 meters on average. Newer GPS receivers with Wide Area Augmentation System (WAAS) capability can achieve an accuracy of better than three meters. WAAS corrects for GPS signal errors caused by ionospheric disturbances, timing and satellite orbit errors and provides vital integrity information regarding the health of each GPS satellite. WAAS includes approximately 25 ground reference stations positioned across the United States to monitor GPS satellite data. Two master stations, located on either coast, collect data from the other 23 reference stations and create a GPS correction message. The correction message accounts for GPS satellite orbit and clock drift as well as signal delays caused by the atmosphere and ionosphere. The corrected differential message is then broadcast through one of two geostationary satellites, i.e., satellites with a fixed position, over the equator. The signals from WAAS are compatible with the basic GPS signal structure. Therefore, any WAAS-enabled GPS receiver can read the signals.

While WAAS was developed by Federal Aviation Administration (FAA) to improve flight safety, the Coast Guard has developed a similar system, the Maritime Differential GPS (DGPS), to improve marine safety along our coasts and the Great Lakes. The DGPS system includes two control centers and more than 60 remote broadcast sites. The system broadcasts correction signals, which are similar to WAAS correction signals, on marine radio beacon frequencies to improve the accuracy of GPS-derived positions. A DGPS-derived position is typically accurate to within 1 to 3 meters. Because DGPS broadcasts at a different frequency, only GPS receivers with add-on devices can take advantage of this service. In addition to WAAS and DGPS, other similar systems may be developed to further improve the accuracy of the location determination by GPS-like technology. These systems will be referred to herein generally as “positioning broadcast systems.” For example, U.S. Pat. No. 6,385,532 B1 issued to Dance et al. discloses a system deployed along highways to improve location determination of vehicles equipped with a GPS like device.

With the ability to find a user's location with an accuracy of three meters or better using GPS or similar systems, many applications are possible. The most common civilian applications include vehicle navigation systems, which may direct drivers to destinations with instructions on which roads to take and when to make a turn. Similarly, GPS has been used to design alarms that notify or alert a user when the user reaches a certain location. For example, U.S. Pat. No. 6,392,548 B2 issued to Farringdon et al. discloses such a location alarm. These devices work by comparing a user's current location as determined by a GPS receiver with a predefined target location (i.e., stored geographical coordinate). When a match is found, the device issues a predetermined alert or instruction to the user. These devices presume that the target coordinates where the events or alarms will be triggered are known before hand so that they can be pre-programmed into the devices.

However, there are situations when the coordinates of the target locations are either unknown beforehand or are too numerous to be listed. In these situations, these target location-based devices are not as useful. For example, there are many situations where an alarm is needed to alert a user when the user reaches within or beyond a certain distance from a reference location, instead of when the user reaches a target location. In these situations, it is cumbersome to enter all target locations along the boundaries, and it is preferable to have devices that are based on distances relative to a reference location rather than actual target coordinates.

### SUMMARY OF INVENTION

One aspect of the invention relates to devices for computing distances based on signals received from GPS or similar systems. An apparatus for distance computation according to one ore more embodiments of the invention includes a location determining device for determining a current location based on signals received from a positioning broadcast system; a memory for storing a coordinate of at least one reference location and at least one program for the distance computation; an input device for entering the coordinate of the at least one reference location; a microprocessor for calculating a distance between the current location and the at least one reference location, the microprocessor operatively coupled to the location determining device and the memory; and an output device operatively coupled to the microprocessor for outputting the calculated distance. The apparatus may further include an alarm setting device operatively coupled to the microprocessor for determining an alarm condition from the calculated distance; and an alarm triggerable by the alarm setting device.

One aspect of the invention relates to methods for generating alarm signals based on signals received from GPS or similar systems. A method for generating a distance-based alarm according to one or more embodiments of the invention includes inputting a coordinate of a reference location; determining a current location based on signals received from a positioning broadcast system; computing a distance from the current user location to the reference location; comparing the distance with a threshold value to see if an alarm condition is met; and outputting a signal if the alarm condition is met.

Other aspects and advantages of the invention will be apparent from the following description and the appended claims.

### BRIEF DESCRIPTION OF DRAWINGS

FIG. 1 is a flow chart of a method according to one embodiment of the invention.

FIG. 2 is a schematic of a distance-based alarm according to one embodiment of the invention.

FIG. 3 is a schematic of a distance-based alarm according to another embodiment of the invention.

### DETAILED DESCRIPTION

Embodiments of the invention relate to methods and apparatuses for calculating distances from users' locations to reference locations based on signals received from the global positioning satellites (GPS) or similar systems. Embodiments of the invention may also provide an alarm or alert to a user when the user goes within or beyond a predetermined distance from a reference location. The alarm signal may be accompanied by a message, e.g., an instruction, an explanation of the alarm situation, etc.

Methods of the invention include calculating a user location (longitude, latitude, and, sometimes, altitude) using GPS or similar system information and calculating a distance from the user location to a reference location based on user's current coordinate and the coordinate of the reference location. The coordinate of a reference location includes a set of coordinate values, which may include a longitudinal value, a latitudinal value, and, sometimes, an altitudinal value. The reference locations may be selected by a user based on a known coordinate (longitude and latitude values) of the location. In this case, the user need not actually have been to the locations. In these embodiments, a device of the invention may include input means, e.g., a keyboard for entering the coordinate or an input/output port for downloading coordinate information from a computer or similar apparatus.

Alternatively, the reference locations may be selected by a user when the user actually visits the location, e.g., the user enters the coordinate calculated by a GPS receiver as the reference location while the user is at the location. In these alternative embodiments, a device may include a button or similar means, which a user may press to input the coordinate of the current location as the reference location coordinate. One or more embodiments of the invention provide both approaches to the entry of reference locations.

In most applications, the 2D geographical coordinates (longitude values and latitude values) of the reference locations are sufficient. However, in some applications, the altitudes of the reference locations may also be required. For example, an alarm device according to the invention may be used as navigational warning systems for helicopters. In these cases, the reference locations may include altitudes denoting the heights of tall buildings or mountains. Using a tall building as an example, the reference locations may include a series of points at the same 2D geographical location (same longitude and latitude), but with different altitudes, to define a series of vertical points, which, together with a safety distance, define a series of overlapping dangerous spheres within which the helicopter should not travel.

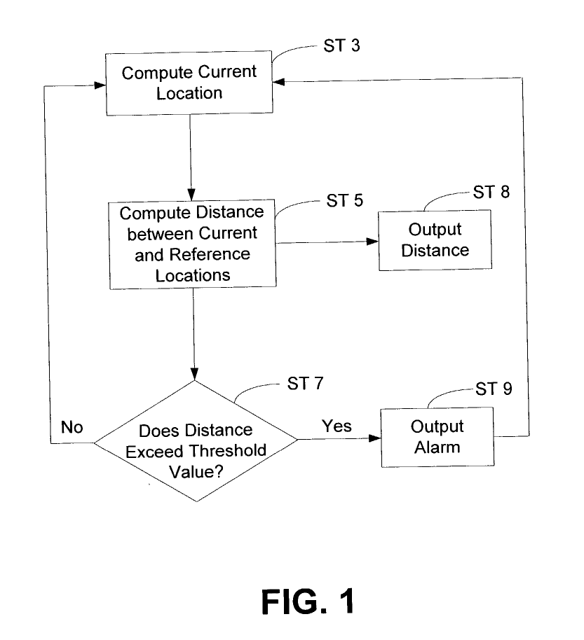

FIG. 1 illustrates a flow chart of a method according to one embodiment of the invention. First, a user's current location is calculated based on the signals received from GPS or similar systems (step 3). As stated above, to triangulate the user's location on the earth surface, signals from three satellites are required. If one is also interested in knowing the altitude of the user's location, signals from four or more satellites are required. Once the user's current location is calculated, the coordinate of this location is used to compute the distance from this location to the reference location(s) (step 5), which have been pre-programmed by methods described above.

To compute the distance between two locations from the locations' geographical coordinates, the difference between the two longitudinal coordinates is converted to a longitudinal distance (d₁) based on a longitudinal conversion factor. Similarly, the difference between the two latitudinal coordinates is converted to a latitudinal distance (d₂) based on a latitudinal conversion factor. These conversion factors can be predetermined and stored in the distance computing device.

The longitudinal and latitudinal conversion factors depend on the latitudes of the locations under consideration. If the current user location and the reference location are located at different latitudes, the average latitudes is used to look up the conversion factors from the stored table. However, if the latitudes of the two locations are not significantly different, the conversion factor would be substantially identical at either location. In this case, either the latitudinal coordinate, instead of the average, may be used to find the conversion factors from the stored table.

The distance between the two locations (d) is then calculated as the square root of the sum of the square of the longitudinal distance (d₁) and the square of the latitudinal distance (d₂), i.e. d=\sqrt{(d₁)²+(d₂)²}. In one or more embodiments, this computed distance is the desired result. The computed distance is then output on the output device.

In one or more embodiments, the distance computing device also includes alarm functions. The computed distance is used to see whether an alarm condition is met. In these embodiments, the distance from the current user location to the reference location is compared with a predetermined threshold value to determine whether an alarm condition is met (step 7). If the computed distance equals or exceeds the threshold value, that is, either the distance is smaller than or greater than the threshold value depending on the particular application, then the alarm condition is met and the device sends an alarm or alert signal to the user (step 9).

In addition, the device may also display the computed distance and any message associated with the alarm condition. For example, the alarm may be associated with a message, which may be a text display or a pre-recorded voice message, alerting the user that he is too close to a specific location, e.g., “you are too close to a shallow spot in the lake.” If the alarm condition is not met, then the device may output the computed distance without any alarm or alert. Whether the alarm condition is met or not, the processes—calculating the user location (step 3), computing the distance to the reference location (step 5), outputting the computed distance (step 8) or comparing the distance with the threshold value (step 7), and sending an alarm if the alarm condition is met (step 9)—are then repeated. In other words, the device resets after each computation and repeats the processes. The device may repeat these processes and update the output continuously or with a preset interval without user's intervention. Alternatively, the user may be provided with an option to request an update of the output as needed.

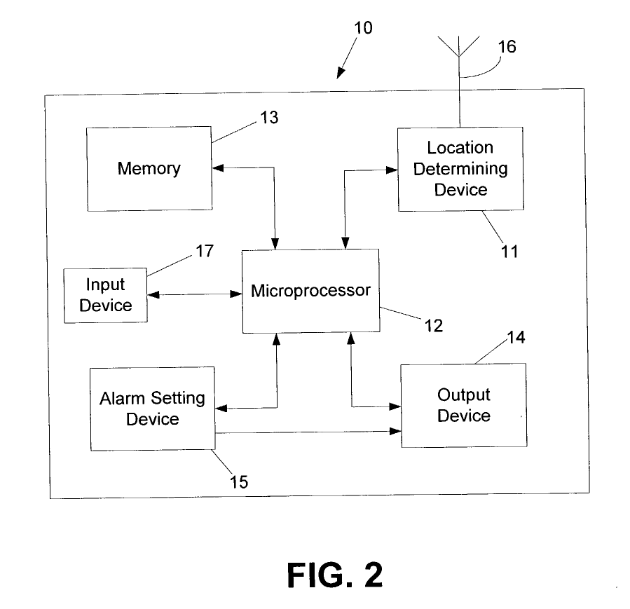

FIG. 2 shows a schematic of one embodiment of the invention. A distance computing device 10 includes a location determining device 11. The location determining device 11 may include an antenna 16 adapted to receive signals from GPS satellites, WAAS, or similar systems. In addition, location determining device 11 may include a clock (not shown) for computing the time of travel for the signal to arrive from the satellites. Alternatively, the clock function may be included as part of a microprocessor 12. The location determining device 11 is in communication with the microprocessor 12. The microprocessor 12 calculates the location of the distance computing device 10 based on GPS information forwarded by the location determining device 11. The microprocessor 12 is in communication with memory 13, which stores necessary programs and parameters. The parameters in memory 13 may also include those for the acquisition of the GPS information, such as specific information on each GPS satellite and temporarily stored almanac information for each GPS satellite. In addition, the memory 13 may also store conversion tables for computing a distance from two spatially-separated points having geographical coordinates (e.g., longitude, latitude, and altitude values).

The microprocessor 12 is also in communication with an output device 14. The output device 14 may be a display unit for displaying the result of distance calculation. The display unit may comprise light-emitting diodes (LED), liquid crystal displays (LCD), thin film transistor (TFT) displays, or the like. For embodiments of the invention that include alarm functions, the output device 14 may further comprise an alarm device (not shown), which may produce any suitable alarm or alert to the user. For example, suitable alarms or alerts may include audible alarms (e.g., sounds produced by a siren/buzzer or a tune/music player), visible alarms (e.g., flashing lights or text displays), motion alarms (e.g., vibration), or combination thereof.

A device of the invention with an alarm function also includes an alarm setting device 15, which may include information as to the threshold distance and the reference points (coordinates). Alarm setting device 15 may also store messages relevant to each alarm conditions. Alternatively, the threshold distance, the reference location coordinate, and/or the alert messages may be stored in memory 13. The alarm setting device 15 is in communication with microprocessor 12, which performs the comparison function to see if the current distance from the reference point exceeds the preset threshold. Alternatively, the comparison function may be performed by a simple circuit that is part of the alarm setting device 15. If the current distance exceeds the threshold value, the microprocessor 12 may send an alarm signal to the output device 14. Alternatively, the microprocessor 12 may instruct the alarm setting device 15 to send an alarm signal to the output device 14.

A distance computing device 10 of the invention may also include an input device 17. The input device 17 may be a keyboard for entering the coordinate of the reference location, a button or similar device for entering the current location as a reference location, or a communication port for uploading and downloading information from a computer or the like. A communication port may be a wired or wireless port. In one or more embodiments, the input device 17 and the output device 14 may be the same unit including a touch sensitive screen, like those used in personal digital assistants (PDA). Users enter the information by touching predefined areas (buttons) on the touch sensitive screens or by writing on the screen using a stylus.

A distance computing device 10 of the invention with an alarm may be useful in land surveys or approximate distance measurements. Embodiments with alarm features may be used, for example, in the following scenarios: warning devices for barges or vessels with known locations of hazards (e.g., shallow areas, bridge posts, rocks) programmed as the references points, and aviation warning devices for helicopters with tall buildings and mountains programmed as the reference points.

In addition, the distance computing device 10 may be used as a navigation device to direct a user to his destination based on a reference location and a list of distance threshold values and messages (e.g., driving directions). The reference location in this case is the user's current location, the coordinate of which can be input by methods described above. The list of driving directions would include a list of threshold distances and the associated messages. For example, a driving direction may read as follows:

| | |
|---|---|
| 1 | From your current location, drive west on Main Street. |
| | 0.06 miles |
| 2 | Turn LEFT onto VELASCO DR. |
| | 0.29 miles |
| 3 | and so on. |

When the user starts out on his journey, he activates the device. The activation process may automatically enter the current location as the reference location into the device 10. The device 10 acknowledges the activation (e.g., beeps) and displays the first message, “Drive West on Main Street.” After the user has traveled a distance that is a short distance (say, 50 feet) shy of the first threshold distance (0.06 miles), the device beeps and displays the next message, “Turn LEFT onto VELASCO DR.” The user would acknowledge the beep. Each time the user acknowledges the beep, the then current location is entered as the new reference locatio, and an internal counter in the device is incremented by one so that the next item on the list of the threshold distances and message will be used for distance comparison and display. Then, the device waits for the user to reach a location that is a short distance (say, 50 feet) shy of the next distance threshold, 0.29 miles, from the last location (the new reference location). The device beeps and displays the next message. The process repeats until the list is exhausted.

In this embodiment, the driving directions (i.e., the list of threshold distances and messages) may be constructed with any commercially available trip mapping programs or from services provided over the Internet, for example, the MapQuest or Yahoo web site. Furthermore, the driving directions may be constructed by a third party and sent to the device user via electronic communication, e.g., sending the list by electronic mail or simply providing a web site link where the device user may download the list. For this application, the input device 17 should comprise a communication port for downloading the list from a computer or a similar device.

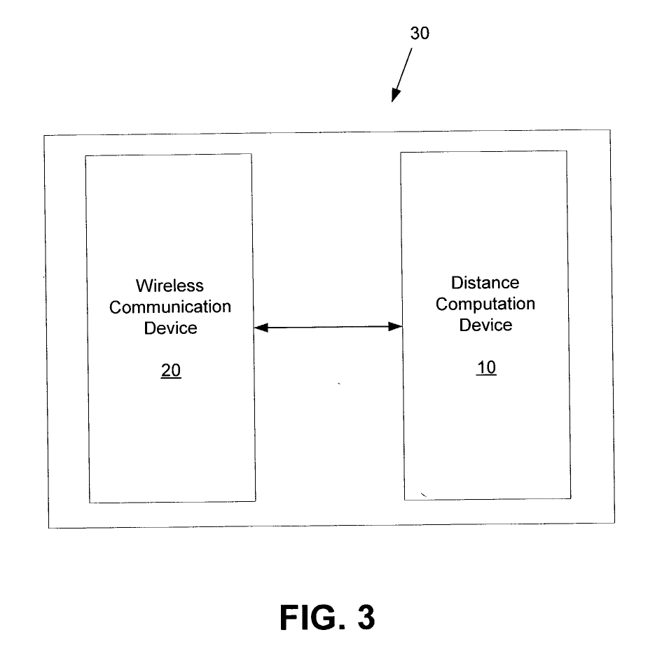

In one or more embodiments, the distance computing device 10 may be coupled to a wireless communication device 20 to form a user device 30 as shown in FIG. 3. The coupling may be achieved by linking the wireless communication device 20 with the microprocessor 12 inside the distance computing device 10. The wireless communication device 20, for example, may be a cellular phone or its equivalent, a wireless text communication or an electronic mail device, or a wireless modem.

In such an embodiment, the output, which may include the computed distance and/or alarm signals, of the distance computing device may be communicated via the communication device 20 to a remote recipient via a communication link, e.g., the internet, a satellite link, a cellular phone network, or the like. The signals communicated by the wireless communication device 20 may include an identification information that uniquely identifies the particular unit of user device 30 so that the recipient can identify which unit sends the signals. In addition, the user device 30 may send the coordinate of the current user location and/or an alarm (alert) message to a remote receiver, which is a device adapted to receive and/or output (e.g., display) the information transmitted by the user device 30. Although the initial transmission is via wireless networks, the transmission path may include wired networks such as the internet, dedicated networks, or telephone networks.

A user device 30 according to this embodiment is useful in the following situations: to set off an alarm when a user holding or wearing the device wanders too far from a reference location, e.g., monitoring devices for parolees, or monitoring devices for a stalker under court restraining orders to stay away from a victim's residence, or substitutes for electronic pet containments sold under the trade name of Invisible Fence™ by the Invisible Fence, Inc. (Malvern, Pa.). With the user device 30, it is possible to monitor the movement of the object wearing or carrying the device 30 and/or to receive an alarm or an alert message when the object travels within or beyond a permitted distance from one or more predetermined reference locations.

While the invention has been described with respect to a limited number of embodiments, those skilled in the art, having the benefit of this disclosure, will appreciate that other embodiments can be devised which do not depart from the scope of the invention as disclosed herein. For example, while the invention has been described using examples of portable devices, embodiments of the invention may also be used as a fixed unit in an automobile, boat, helicopter, or the like. Furthermore, while the examples described here use signals from GPS and WAAS, signals from other similar positioning systems, i.e., positioning broadcast systems, may be used. Accordingly, the scope of the invention should be limited only by the attached claims.

What is claimed is:

1. An apparatus for distance computation, comprising:
a location determining device for determining a current location based on signals received from a positioning broadcast system;
a memory for storing a coordinate of at least one reference location and at least one program for the distance computation;
an input device for entering the coordinate of the at least one reference location, the input device operatively coupled to the memory;
a microprocessor for calculating a distance between the current location and the at least one reference location, the microprocessor operatively coupled to the location determining device and the memory; and
an output device operatively coupled to the microprocessor for outputting the calculated distance.

2. The apparatus of claim 1, wherein the output device comprises at least one selected from the group consisting of a liquid crystal display, a light emitting diode, a thin film transistor display, a light bulb for flashing a signal, an audio device, and a vibrator.

3. The apparatus of claim 1, further comprising:
a wireless communication unit operatively coupled to the microprocessor, the wireless communication unit adapted to send a coordinate of the current location to a remote receiver.

4. The apparatus of claim 3, wherein the wireless communication unit comprises one selected from the group consisting of a cellular phone, a wireless modem, and a wireless text messaging device.

5. The apparatus of claim 1, wherein the positioning broadcast system comprises one selected from the group consisting of a global positioning satellite system, a wide area augmentation system, and a maritime differential global positioning satellite system.

6. The apparatus of claim 1, wherein the coordinate of the at least one reference location comprise longitude value, latitude value, and altitude value.

7. The apparatus of claim 1, further comprising:
an alarm setting device operatively coupled to the microprocessor for determining an alarm condition from the calculated distance; and
an alarm triggerable by the alarm setting device.

8. The apparatus of claim 7, wherein the alarm is part of the output device.

9. The apparatus of claim 7, further comprising:
a wireless communication unit operatively coupled to the microprocessor, the wireless communication unit adapted to sent a message to a remote receiver.

10. The apparatus of claim 9, wherein the message comprises at least one selected from the group consisting of a coordinate of the current location, the distance, and an alarm signal.

11. The apparatus of claim 9, wherein the wireless communication unit comprises one selected from the group consisting of a cellular phone, a wireless modem, and a wireless text messaging device.

12. The apparatus of claim 7, wherein the positioning broadcast system comprises one selected from the group consisting of a global positioning satellite system, a wide area augmentation system, and a maritime differential global positioning satellite system.

13. The apparatus of claim 7, wherein the output device comprises at least one selected from the group consisting of a liquid crystal display, a light emitting diode, a thin film transistor display, a light bulb for flashing a signal, an audio device, and a vibrator.

14. An apparatus for distance computation, comprising:
means for determining a current location based on signals received from a positioning broadcast system;
memory for storing a coordinate of at least one reference location and at least one program for the distance computation;
means for entering the coordinate of the at least one reference location;
means for calculating a distance between the current location and the at least one reference location, the means for calculating operatively coupled to the memory and the means for determining the current location; and
means for outputting the calculated distance, the means for outputting operatively coupled to the means for calculating.

15. The apparatus of claim 14, further comprising:
means for determining an alarm condition from the calculated distance, the means for determining an alarm condition operatively coupled to the means for calculating; and
means for outputting an alarm signal, the means for outputting an alarm signal triggerable by the means for determining an alarm condition.

16. The apparatus of claim 15, further comprising:
means for wireless communication, the means for wireless communication operatively coupled to the means for calculating.

17. A navigation device, comprising:
a location determining device for determining a current location based on signals received from a positioning broadcast system;
a memory for storing a coordinate of a reference location, at least one program for distance computation, and a list of threshold distances and messages;
an input device for entering the list of threshold distances and messages, the input device operatively coupled to the memory;
a microprocessor for calculating a distance between the current location and the reference location, the microprocessor operatively coupled to the location determining device and the memory;
means for determining an alarm condition based on the calculated distance and the list of the threshold distances, the means for determining an alarm condition operatively coupled to the memory and the microprocessor; and
an output device for outputting an alarm signal, the output device operatively coupled to the memory and the microprocessor.

18. A method for generating a distance-based alarm, comprising:
inputting a coordinate of a reference location;
determining a current location based on signals received from a positioning broadcast system;
computing a distance from the current location to the reference location;
comparing the distance with a threshold value to see if an alarm condition is met; and
outputting a signal if the alarm condition is met.

19. The method of claim 18, wherein the positioning broadcast system comprises one selected from the group consisting of a global positioning satellite system, a wide area augmentation system, and a maritime differential global positioning satellite system.

20. The method of claim 18, wherein the outputting the alarm signal comprises sending the alarm signal via communication means to a remote receiver.

21. The method of claim 20, wherein the signal comprises at least one selected from the group consisting of a coordinate of the current location, the distance, and a message.
